(19) United States
(12) Patent Application Publication
(10) Pub. No.: US 2018/0019089 A1
(43) Pub. Date: Jan. 18, 2018

(54) IMPROVED MATERIALS AND STRUCTURES FOR LARGE AREA X-RAY DECTECTOR WINDOWS

(71) Applicant: Luxel Corporation, Friday Harbor, WA (US)

(72) Inventors: Bruce Michael Lairson, Friday Harbor, WA (US); Travis Ellis Ayers, Friday Harbor, WA (US); Heidi Hilfiker-deLopez, Friday Harbor, WA (US); Jeffrey Leonard Durham-Guckian, Friday Harbor, WA (US)

(21) Appl. No.: 15/545,006

(22) PCT Filed: Jan. 22, 2016
(86) PCT No.: PCT/US16/14599

§ 371 Date: Jul. 20, 2017

Related U.S. Application Data
(60) Provisional application No. 62/106,337, filed on Jan. 22, 2015.

(51) Int. Cl. H01J 5/18

(52) U.S. Cl. CPC H01J 5/18

(57) ABSTRACT

Embodiments for detectors windows up to 100 mm are disclosed.

### CROSS-REFERENCES TO RELATED APPLICATIONS

This application takes priority to PCT/US16/14599, filed on 22 Jan. 2016 which takes priority to provisional application No. 62/106,337 filed on Jan. 22, 2015 and incorporated herein, in its entirety, by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Metrology tools that utilize X-rays require detector windows which separate the harsh plasma environment of an X-ray source from the ultraclean environment of the metrology tool. FIG. 1 is an exemplary configuration showing how a detector window may be used. An excitation beam creates an X-ray source which is detected by a calorimeter through a detector window and set of shields. The detector window is the primary contamination shield and vacuum interface; the inner shields are contamination and thermal barriers. Detector windows are generally made of thin films which are comprised of beryllium, diamond, graphene, diamond-like carbon, or a combination thereof.

Detector window films are thin and must be supported by structures typically comprised of ribs supported by a frame. The ribs, frames, or a combination thereof is known as a support structure. Support structures prevents window films from sagging or breaking. However, a support structure can also interfere with the passage of X-rays. Consequently, support structures must be optimized to have the lowest possible thickness and width while providing the largest amount of strength to the thin window.

Large-area soft X-ray windows, up to 100 mm, are needed for emerging technologies that have large apertures such as cryo-detector arrays, semiconductor lithography, and pulsed light sources. Known detector windows cannot be proportionally scaled. Increasing film thickness will increase X-ray absorption. Further, if film thickness is increased, then support structure must be made proportionally larger to support the larger film. However, increasing the dimensions of the support structure causes shadowing of pixels near the edges of the support structure.

### SUMMARY OF THE INVENTION

It has been recognized that it would be advantageous to provide a detector window that will have low failure rates for apertures up to 100 mm. Desirable characteristics of the detector window include minimal X-ray attenuation, ability to withstand high strength and high pressure differentials, typically 1 atmosphere.

### BRIEF DESCRIPTION OF THE DRAWINGS

Other features and advantages of the present invention will become apparent in the following detailed descriptions of the preferred embodiment with reference to the accompanying drawings, of which:

FIG. 1 is an exemplary configuration showing how a detector window may be used;

FIG. 2 is an exemplary configuration showing how grid supports and thin films may be stacked;

FIG. 3 is a perspective view of an enlarged section of a typical grid support;

FIG. 4A is a perspective view of an exemplary domed grid support;

FIG. 4B is an enlarged view of taken from FIG. 4A;

FIG. 5 is a sectional view taken from 5-5 of FIG. 4B;

FIG. 6 is a sectional view of the stacked domed grid;

FIG. 7 is a sectional view of the stacked dome gird where each grid and a different pitch;

FIG. 8A is the transmitted light image of a detector window having at least three stacked focus grid supports;

FIG. 8B is a difference image between separate transmitted images of a 389-micron pitch stacked focus grid and a 390-micron pitch stacked focus grid;

FIG. 9 is an enlarged section of a grid support.

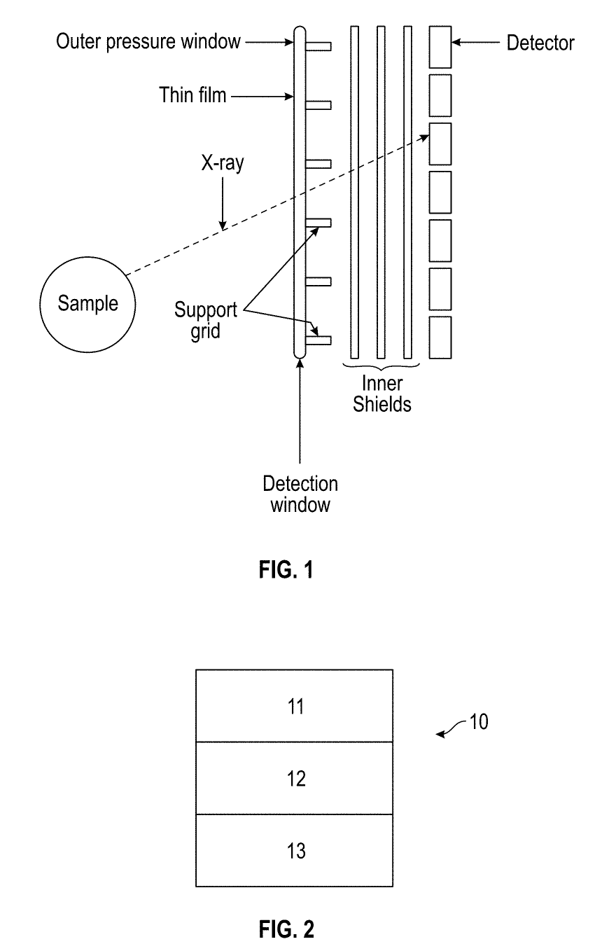

### DETAILED DESCRIPTION OF THE INVENTION

In the following detailed description, reference is made to the accompanying drawings, which form a part hereof. In the drawings, the use of similar or the same symbols in different drawings typically indicate similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here. One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. By way of overview, embodiments provide improved detector windows for apertures up to 100 mm.

Grid supports have been used for soft X-ray windows. However, grid supports are expensive to fabricate. Poorly made grid supports cause shadowing, florescence, and/or are fragile. Properly fabricated grid supports may provide the strength needed to support large-area detector windows. Stacking grid supports reduces peak bending moments and achieves geometric aspect ratios of at least 1 but, preferably between 1 and 5. Geometric aspect ratio is defined as the total thickness of a grid support in the direction of the incident beam divided by the width of a grid bar. Grid supports may be fabricated by any known method such as etching of single crystal silicon, photoetching, or machine operations, amongst others.

Referring to FIG. 2, exemplary configurations of a detector window (10) is shown. The detector window (10) is comprised of a plurality of layers (11, 12, 13) stacked together. Although three layers are shown here for exemplary purposes, it will be understood that any number of layers may define the inventions discussed herein. At least one layer is a thin film and at least two layers are grid supports. In one embodiment, the grid supports (12,13) are stacked and/or operably attached onto each other; the thin film (11) is operably attached to the stacked grid supports (12, 13). In another embodiment, the thin film (11) is sandwiched in between the grid supports (12,13).

The thin film may be comprised of beryllium, aluminum, Polyimide, carbon, boron nitride, or a combination thereof. The thin film may be operably attached to the grid supports using any known method such as adhesives, metallic bonding, chemical bonding with a reactive polymer. Preferably, the grid supports are fabricated from stainless steel, aluminum, carbon, titanium, beryllium, or a combination thereof. The stacked grid supports may be operably attached to each other using epoxy or any other know attachment method.

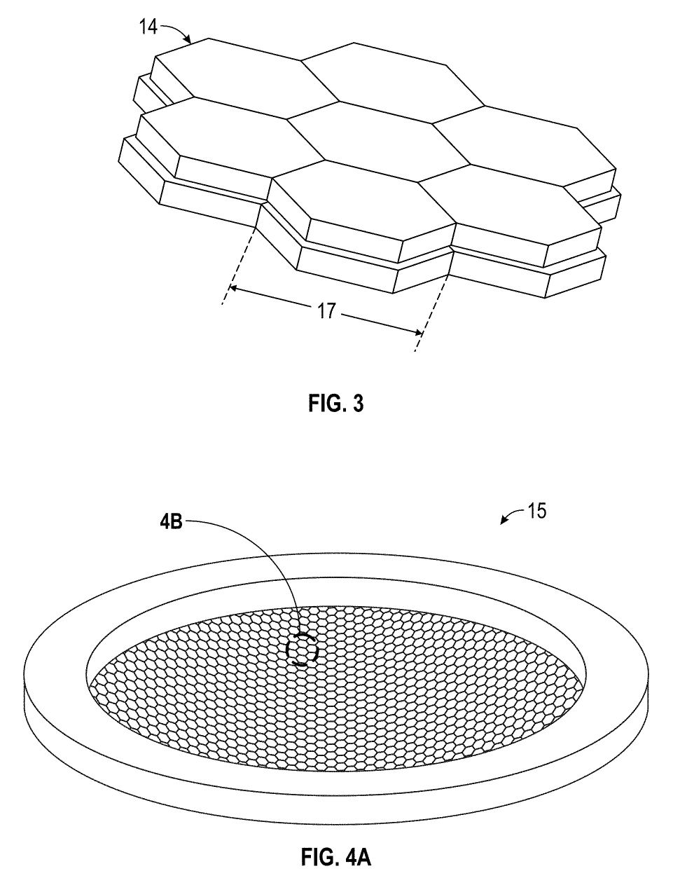

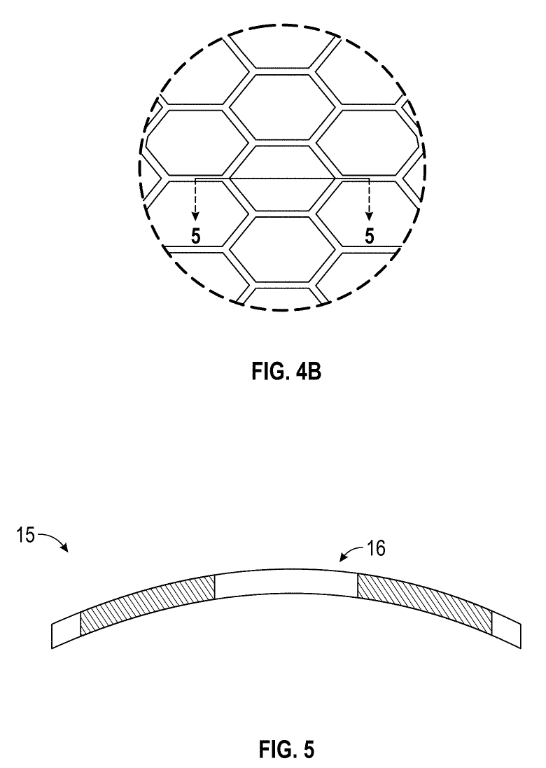

FIG. 3 shows a typical section of a grid support (14). Although the grid support (14) is shown herein as hexagonal, it will be understood that the grid support shape can be any geometric shape. Referring to FIGS. 3, 4A, 4B and 5, in one embodiment, a typical grid support (14) is deformed into a spherical segment or dome grid support (15). FIG. 4A shows a typical dome grid support (15).

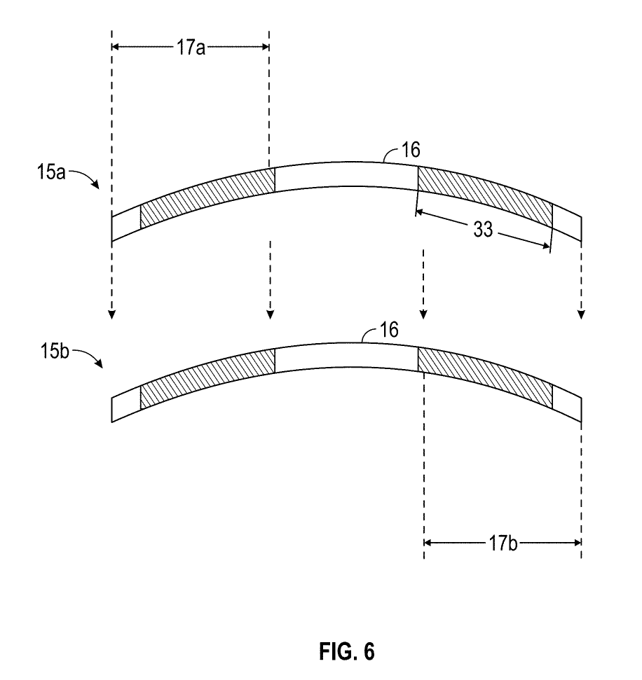

Referring to FIG. 6, in one embodiment, at least two dome grid supports (15) are stacked and/or operably attached to each other. The stacked dome grid supports (15) may be operably attached to each other using epoxy or any other know attachment technique.

In one embodiment, the pitch (17a) of one dome grid support (15a) is different than the pitch (17b) of the other dome grid support (15a). Preferably, the pitches (17a, 17b) of the dome grid support (15a, 15b) are between 200 and 500. Preferably, the dome grid supports (15) are fabricated using soft, diffusion joined grids. Preferably, the dome grid supports (15) defines an open area (16) of at least 80%. Any thin film may be attached to the stacked dome grid supports (15) using any know method such as adhesives, metallic bonding, chemical bonding with a reactive polymer, amongst others.

In one embodiment the thin film is the commercially available LEX® Light Element X-ray thin film which is attached to a 25 mm window, and the dome grid supports (15) are fabricated from stainless steel. In this embodiment, the detector window (10) has a geometric transmittance of 80% for a point source located 50 mm from the detector window face.

Confocal microscope XYZ scans of the domed grid supports allows direct computation of strain, curvature, and surface tension on a detector window (10). In this embodiment, the stainless steel grid support is deformed by 4%, and the average bar stress is 220 MPa. Bar stress is defined as the uniaxial stress at a bar which is part of a grid support; average bar stress is the average of the bar stress over the volume of an entire grid support.

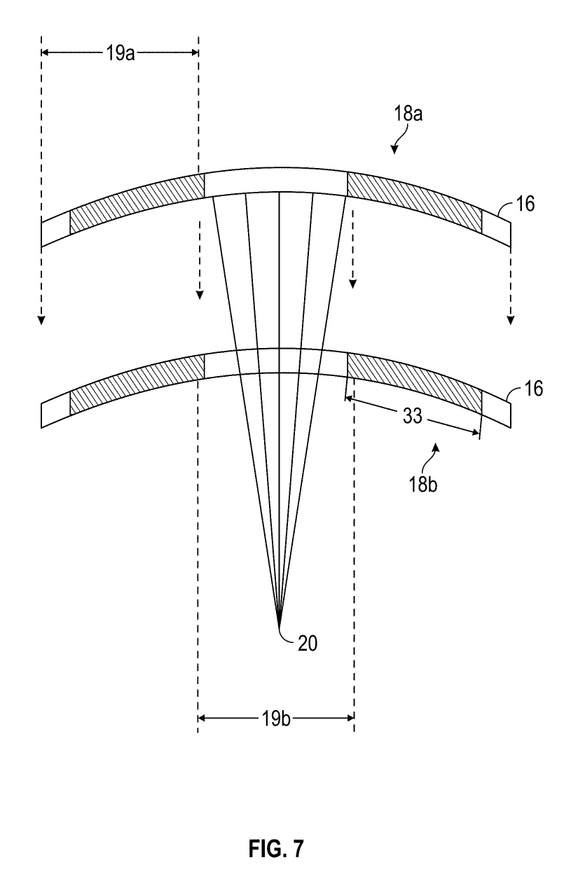

Referring to FIG. 7, in another embodiment, the detector window is comprised of at least two grid supports (18a, 18b) where each grid support has a different pitch (19a, 19b). The grid supports (18a, 18b) are stacked and/or operably joined to each other. The stacked grid supports (18) may be operably attached to each other using epoxy or any other know attachment technique. The stacked grid supports (18a, 18b) have a fixed focal point (20). The focal point (20) is selectable between a millimeter and infinity. This geometry is known as the stacked focus grid (18).

The stacked focus grid (18) geometry places lower grid bars into the shadow of the top grid bars consequently, negligible grid occlusion occurs as grid supports are added. The thin film may be comprised of beryllium, aluminum, Polyimide, carbon, boron nitride, or a combination thereof. The thin film may be operably attached to the stacked focus grids (18) using any known method such as adhesives, metallic bonding, chemical bonding with a reactive polymer, for example. Preferably, the stacked focus grids (18) are fabricated from stainless steel, aluminum, carbon, titanium, beryllium, or a combination thereof.

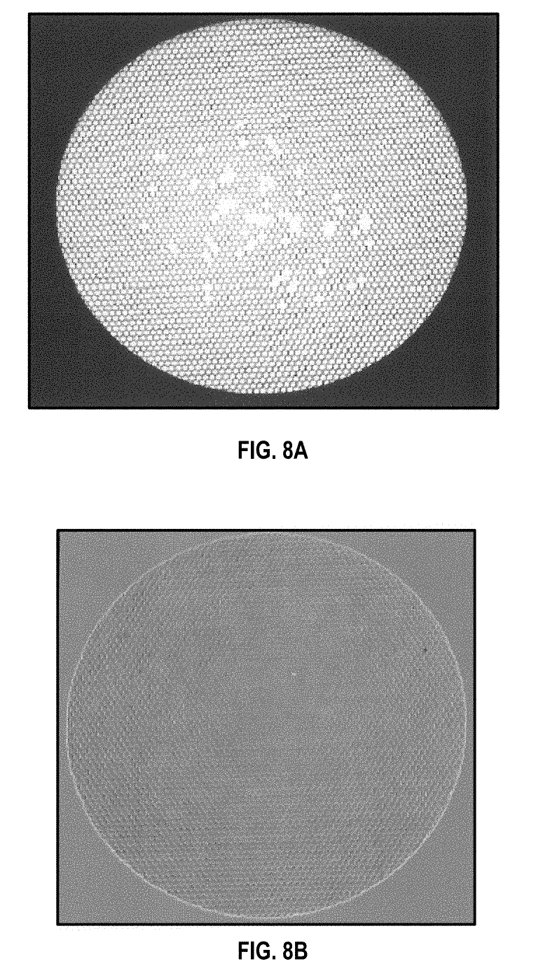

The quality of alignment and mesh lithography are assessed by transmitted imaging of the stacked focus grids (18) and grids supports that were not stacked. Typical results can be seen in FIGS. 8A and 8B. FIG. 8A is the transmitted light image of a detector window (10) having at least three stacked focus grids (18) where two stacked focus grids (18) have the same pitch, preferably between 200 and 500 microns. The third stacked focus grid (18) has a pitch different than the other two but, preferably between 200 and 500 microns.

FIG. 8B is a difference image between separate transmitted images of a 389-micron pitch stacked focus grid (18) and a 390-micron pitch grid. The bright ring at the outer diameter is due to the difference in the apertures. The residual intensity is brightest near the aperture edges caused by the differences in pitch between the two grid supports. Samples of patterning error about the aperture between the two grids shows an average patterning mismatch of less than 5 microns.

In this embodiment, the stacked focus grids (18) have an open area (16) of 88% and an average bar width (33) of 25 microns. For a source 20 mm from the detector window (10), the transmittance is approximately 87% at the center and 78% at the edge of the detector window (10). In this embodiment, transmittance at the edge of the detector window (10) falls to 70% for a source at an infinite distance. The transmittance at the center is 87% and 74% at the edge of the detector window (10) when the X-ray source is approximately 30 mm from the detector window (10).

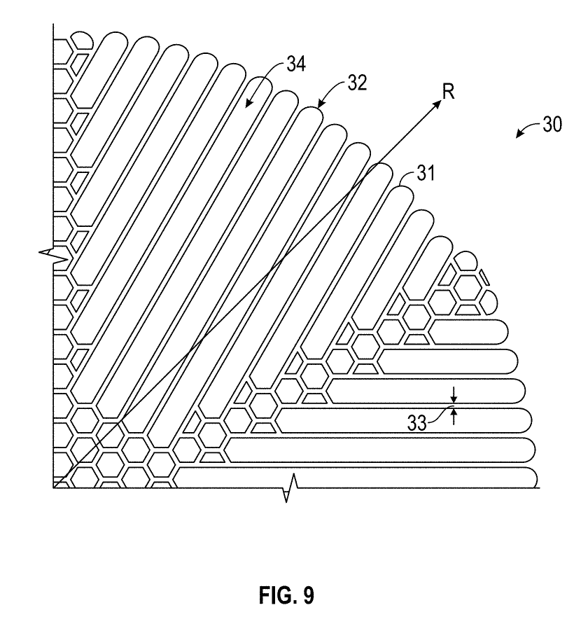

Referring to FIG. 9, in another embodiment, at least one grid support (30) is operably attached to at least one thin film (31) where the grid support (30) is defined by approximately finger shaped bars (32) which define a slot (34). Each finger shaped bar (32) has approximately the same bar width (33) and are dispersed radially (R) on the grid support (30). This slotted grid support (30) reduces areal blocking.

The slotted gird support (30) provides an open area of at least 80%. In comparison, a typical hexagonal grid support (FIG. 3), known in the art, and fabricated with the same or similar design rules provides an open area of 76%. Additionally, the slotted grid support (30) yields half the florescence of a hexagonal grid support.

In one embodiment the bar width (33) is at least 30 microns. In one embodiment, each slot (32) has at least a 210 micron opening. In one embodiment, the slot grid support (30) may be fabricated from stainless steel. In one embodiments, the slot grid support (30) may be fabricated from ultra-strong, low Z materials such as carbon fiber or Vectran. The thin film may be comprised of beryllium, aluminum, Polyimide, carbon, boron nitride, or a combination thereof. The thin film may be operably attached to the slotted support grid (30) using any known method such as adhesives, metallic bonding, chemical bonding with a reactive polymer, for example.

What is claimed is:

1. A detector window for apertures up to 100 mm comprised of a thin film layer operably attached to at least two stacked grid supports.

2. The detector window of claim 1 where the thin film is selected from the group consisting of beryllium, aluminum, Polyimide, carbon, boron nitride, or combination thereof.

3. The detector window of claim 1 where the grid supports are fabricated from material chosen from a group consisting of stainless steel, aluminum, carbon, titanium, beryllium, or a combination thereof.

4. The detector window of claim 1 where at least one grid support is hexagonally shaped.

5. The detector window of claim 4 where at least one grid support is deformed into a spherical segment or dome grid support.

6. The detector window of claim 5 where the at least one dome grid support is fabricated using soft, diffusion joined grids; where the domed grid support has an opening of at least 80%.

7. The detector window of claim 6 where there are at least two domed grid supports; where each domed grid support has a pitch; where the pitch of one dome grid support is not equal to the pitch of the other doomed grid support; where the pitch of each doomed grid support is between 200 and 500 microns.

8. A detector window for apertures up to 100 mm comprising of a thin film operably attached to at least two hexagonal grid supports; where the thin film is LEX® Light Element X-ray thin film; where the grids are made of stainless steel.

9. The detector window of claim 8 where the geometric transmittance is at least 80%.

10. A detector window for apertures up to 100 mm comprised of a thin film operably attached to at least two grid supports; where each grid support has a pitch different than the pitch of the other grid support; where the grid supports are stacked; where the stacked grid supports have a fixed focal point.

11. The detector window of claim 10 where the fixed focal point is between 1 mm and infinity.

12. The detector window of claim 10 having three stacked grid supports; where two grid supports have the same pitch and one grid support has a different pitch; where the pitch of each grid support is between 200 and 500 microns; where the stacked grid supports have at least an 80% opening.

13. A detector window for apertures up to 100 mm comprised of a thin film operably attached to at least one grid support has a plurality of approximately finger shaped bars; where each approximately finger shaped bar defines a slot; where each of the plurality of finger shaped bars have approximately the same bar width; where each finger shaped bar is dispersed radially on the grid support.

14. The detector window of claim 13 where the bar width is at least 10 microns; where each slot is at least a 100 microns.

15. The detector window of claim 13 where the grid support is fabricated from stainless steel, carbon fiber, Vectran, titanium, beryllium, or a combination thereof.

16. A method to make a detector window comprises operably attaching a thin film to at least two stacked grid supports.

17. The method of claim 16 where the at least two grid supports are deformed.

18. The method of claim 17 where the at least two grid supports have different pitches.

19. The method of claim 18 where the at least two grid supports have a common focal point.

20. A method to make a detector window comprises operably attaching a thin film to a grid support; where the at least one grid support has a plurality of approximately finger shaped bars; where each approximately finger shaped bar defines a slot; where each of the plurality of finger shaped bars have approximately the same bar width; where each finger shaped bar is dispersed radially on the support grid.
